(19) United States
(12) Patent Application Publication
(10) Pub. No.: US 2016/0114302 A1
(43) Pub. Date: Apr. 28, 2016

(54) DISPERSION OF SULFUR BY AMPHIPHILIC PROTEINS

(71) Applicant: E I DU PONT DE NEMOURS AND COMPANY, Wilmington, DE (US)

(72) Inventors: FAN LI, WILMINGTON, DE (US); ERENA FARAH OUSMAN, NEWARK, DE (US); VICTORIA RISHTON, LANCASHIRE (GB)

(21) Appl. No.: 14/522,629

(22) Filed: Oct. 24, 2014

(51) Int. Cl. B01F 17/00; C01B 17/02

(52) U.S. Cl. CPC B01F 17/005; C01B 17/0248

(57) ABSTRACT

Dispersion of elemental sulfur in amphiphilic proteins. The elemental sulfur dispersed in aqueous solutions with one or more amphiphilic proteins. A process using one or more hydrophobins to disperse the elemental sulfur in an aqueous solution. Further a process using bovine serum albumin to disperse elemental sulfur in an aqueous solution.

### FIELD OF INVENTION

The instant invention relates to the field of dispersion of elemental sulfur. Specifically it relates to a process for dispersion of elemental sulfur in aqueous solutions. More specifically it relates to a process for dispersion of elemental sulfur by amphiphilic proteins.

### BACKGROUND

Elemental sulfur has been widely used in several industries such as pharmaceutical, agricultural, lead-acid battery and rubber. In most applications dealing with sulfur insolubility and its safety hazards has been a serious problem.

Elemental sulfur is a pale yellow, odorless and brittle material. The formal valence of elemental sulfur is zero (S⁰), however, elemental sulfur tends to catenate and form chains of various lengths (S_{∞} or S_{μ}) and ring sizes (Sₙ) (Steudel, R., Environmental Technology to Treat Sulfur Pollution, page 1-31, edited by P. Lens, et al., London: IWA Publishing, 2000). Cyclic, orthorhombic α-sulfur (α-S₈) (cyclo-octasulfur or S₈ rings) is the thermodynamically most stable form of elemental sulfur at ambient temperature and pressure. Accordingly, cyclo-octasulfur (also known as flowers of sulfur) is one of the main components of typical commercially available elemental sulfur. In addition, elemental sulfur always contains some polymeric sulfur consisting of chain-like macromolecules as well as large Sₙ (n>50) rings. Due to this complex structure elemental sulfur is highly hydrophobic and thus insoluble in water.

Elemental sulfur is highly sought after as a slow release fertilizer. However, the elemental sulfur particle is dependent on microbial colonization of its surface and subsequent oxidation in soil to become suitable for plant uptake. The particle size of the elemental sulfur greatly affects oxidation rates, i.e., oxidation rate increases as particle size decreases. Thus, dispersion of elemental sulfur into small micronized particles in the soil greatly enhances its oxidation rate (Schoenau, J. et al., Sulfur: a missing link between, soils, crops, and nutrition, Agronomy monograph, No. 50, chapter 1, 2008)

U.S. Pat. No. 5,653,782 discloses manufacture of sulfur-containing fertilizers wherein substrates containing fertilizer particles are heated to a temperature above the melting point of sulfur and admixed with sulfur.

Elemental sulfur has also been used in preparation of sulfur-containing medications such as ointments used for skin disorders like eczema, dermatitis, and psoriasis. International Patent Application Publication WO 2007/140588 discloses preparation of micron-sized (300 microns) sulfur particles together with sodium lignin sulfonate as the excipient for a pharmaceutical preparation for treating pneumonia, herpes and psoriasis.

More recently, sulfur has found use in the Lithium ion battery, owing to its high capacity. However, as sulfur is an insulator in such applications, its dispersion and intimate mixing with conductive binders would be critical in electrode fabrication (J. Mater. Chem., 20: 9821-9826, 2010).

Regardless of the improvements in the art, problems with the manufacturing processes, such as fertilizers and pharmaceutical chemicals, containing elemental sulfur still exist. In particular, dust and explosion hazards involving elemental sulfur dust continue to be of great concern. Thus safe solubilization of the hydrophobic elemental sulfur for use in various applications is of great interest. To this end, U.S. Pat. No. 5,423,897 discloses the use of coating agents, e.g., incorporating surfactants, in the reduction of dust formation and caking during use and handling of some sulfur-containing fertilizers.

### SUMMARY OF INVENTION

The instant invention provides a process for preparing elemental sulfur dispersions using one or more amphiphilic proteins.

In one aspect the instant invention is a process for preparing an aqueous dispersion of elemental sulfur, the process comprising the step of mixing one or more amphiphilic proteins, elemental sulfur and water to form an aqueous dispersion of elemental sulfur.

In another aspect the invention is a composition comprising elemental sulfur coated with an amphiphilic protein.

### DESCRIPTION OF FIGURES

FIG. 1A shows a time sequence of bottles containing an aqueous solution with no hydrophobin and 1% elemental sulfur at 0 hour, 1 hour and 24 hours. The yellow color of the elemental sulfur that is not dispersed in the solution can be seen clearly. FIG. 1B shows a time sequence of bottles containing an aqueous solution plus 0.01% hydrophobin protein and 1% elemental sulfur at 0 hour, 1 hour and 24 hours. No yellow color is visible and no precipitation of elemental sulfur can be observed even after 24 hours.

FIG. 2A shows a time sequence of bottles containing an aqueous solution with no hydrophobin and 10% elemental sulfur at 0 hour, 1 hour and 24 hours. The yellow color of the elemental sulfur that is not dispersed in the solution can be seen clearly. FIG. 2B shows a time sequence of bottles containing an aqueous solution plus 0.1% hydrophobin protein and 10% elemental sulfur at 0 hour, 1 hour and 24 hours. A stable dispersion is obtained with only minor precipitation of elemental sulfur even after 24 hours.

### DETAILED DESCRIPTION OF INVENTION

The invention disclosed herein relates to a process for preparing an elemental sulfur aqueous dispersion using amphiphilic proteins. An aqueous dispersion of sulfur, as described herein, refers to a system in which elemental sulfur particles are uniformly distributed in water or an aqueous mixture to provide a continuous phase aqueous solution of sulfur. An aqueous solution of sulfur as disclosed in the instant invention can comprise at least 50% water. The aqueous solution, in addition to water, amphiphilic proteins and sulfur, can comprise optional components such as additives and/or adjuvants. Examples of such components include, surfactants, e.g., anionic, non-ionic, amphoteric and/or cationic surfactants, acids or bases; non-ionic polymers; polyelectrolytes; buffer systems; inorganic particles, such as SiO₂ or silicates dyestuff; or biocide; UV absorber; solvents, solvent mixtures and free-radical trapping agents. Additives can be selected depending on the application or intended use of the dispersed elemental sulfur obtained by the process described herein, or otherwise based on desirable properties or performance enhancements that can result from use of such additives.

The term “continuous phase”, as used herein, refers to an aqueous solution in which particles of the elemental sulfur are dispersed in the solution and remain as such without precipitating upon standing stationary for at least 24 hours.

The term “amphiphilic proteins”, as used herein, refers to proteins that possess both hydrophilic and hydrophobic domains. Some amphiphilic proteins function through self-assembling at hydrophobic-hydrophilic interfaces. Amphiphilic proteins possess surface activity and are effective in reducing water surface tension, stabilizing liquid foam, surface coatings and particle dispersion. These proteins are highly efficient and are usually effective at concentrations 1-3 orders of magnitude less than surfactants and even fluorosurfactants. Amphiphilic proteins can be used as an additive at very small quantities to greatly enhance interfacial elasticity and facilitate adhesion on various surfaces. Amphiphilic proteins are usually biodegradable and safe for human and environment. An example of amphiphilic proteins suitable for application in the instant invention is a group of small cysteine-rich amphiphilic structural proteins produced by microorganisms called hydrophobins.

In the instant invention, the term “hydrophobin” refers to a polypeptide capable of self-assembly at a hydrophilic/hydrophobic interface, and having the general formula (I):

(Y₁)ₙ—B₁—(X₁)ₐ—B₂—(X₂)_{b}—B₃—(X₃)_{c}—B₄—(X₄)_{d}—B₅—(X₅)ₑ—B₆—(X₆)_{f}—B₇—(X₇)_{g}—B₈—(Y₂)ₘ (I)

wherein: m and n can be independently 0 to 2000; B₁, B₂, B₃, B₄, B₅, B₆, B₇ and B₈ can be each independently amino acids selected from cysteine (Cys), leucine (Leu), alanine (Ala), proline (Pro), serine (Ser), threonine (Thr), methionine (Met) or glycine (Gly), wherein at least 6 of the residues B₁ through B₈ are Cys; X₁, X₂, X₃, X₄, X₅, X₆, X₇, Y₁ and Y₂ each independently represent any amino acid; a can be 1 to 50; b can be 0 to 5; c can be 1 to 100; d can be 1 to 100; e can be 1 to 50; f can be 0 to 5; and g can be 1 to 100.

The suitable hydrophobin for the instant invention can have a sequence of between 40 and 120 amino acids in the hydrophobin core. In some embodiments, the hydrophobin can have a sequence of between 45 and 100 amino acids in the hydrophobin core. In some embodiments, the hydrophobin can have a sequence of between 50 and 90, preferably 50 to 75, or 55 to 65 amino acids in the hydrophobin core. The term “the hydrophobin core” means the amino acid sequence beginning with the residue B₁ and terminating with the residue B₈.

In the formula (I), Y₂ is optional, and therefore in some embodiments “m” can be 0, or alternatively can be any integer up to 500.

In the formula (I), Y₁ is optional, and therefore in some embodiments “n” can be 0, or alternatively can any integer up to 500.

In the formula (I), in some embodiments, “a” can be any integer from 3 to 25, or alternatively any integer from 5 to 15.

In the formula (I), X₂ is optional, but can be present in some embodiments, and therefore “b” can alternatively be 0, 1, or 2. Preferably b is 0.

In the formula (I), in some embodiments, “c” can be any integer from 5 to 50, or alternatively from 5 to 40.

In the formula (I), in some embodiments, “d” can be any integer from 2 to 35, or alternatively from 4 to 23.

In the formula (I), in some embodiments, “e” can be any integer from 2 to 15, or alternatively from 5 to 12.

In the formula (I), X₆ is optional, but can be present in some embodiments, therefore “f” can alternatively be 0, 1 or 2.

In the formula (I), in some embodiments, “g” can be any integer from 3 to 35, or alternatively from 6 to 21.

Hydrophobins suitable for use in the practice of the instant invention can alternatively have the general formula (II):

(Y₁)ₙ—B₁—(X₁)ₐ—B₂—(X₂)_{b}—B₃—(X₃)_{c}—B₄—(X₄)_{d}—B₈—(X₈)ₑ—B₈—(X₈)_{f}—B₇—(X₇)_{g}—B₈—(Y₂)ₘ (II)

wherein: Y₁, Y₂ and X₁ through X₇, are as defined above for formula (I); “m” and “n” can be independently 0 to 20; B₁, B₂, B₃, B₄, B₅, B₆, B₇ and B₈ can each independently be an amino acid selected from the group consisting of Cys, Leu, Ala, Pro, Ser, Thr, Met or Gly, wherein at least 7 of the residues B₁ through B₈ are Cys; “a” can be any integer from 3 to 25; “b” can be 0, 1 or 2; “c” can be any integer from 5 to 50; “d” can be any integer from 2 to 35; “e” can be any integer from 2 to 15; “f” can be 0, 1 or 2; and “g” can be any integer from 3 to 35.

The suitable hydrophobins for the instant invention can alternatively have the general formula (III):

(Y₁)ₙ—B₁—(X₁)ₐ—B₂-B₃—(X₃)_{c}—B₄—(X₄)_{d}—B₅—(X₅)ₑ—B₆-B₇—(X₇)_{g}—B₈—(Y₂)ₘ (III)

wherein: Y₁, Y₂ and X₁, X₃, X₄, X₅, and X₇, are as defined above for formula (I); m and n can each independently be any integer from 0 to 20; B₁, B₂, B₃, B₄, B₅, B₆, B₇ and B₈ can each independently be an amino acid selected from the group consisting of Cys, Leu, Ala, Pro, Ser, Thr, Met or Gly, wherein at least 7 of the residues B₁ through B₈ are Cys; “a” can be an integer from 5 to 15; “c” can be an integer from 5 to 40; “d” can be an integer 4 to 23; “e” can be an integer from 5 to 12; and “g” can be an integer from 6 to 21.

In the formulae (I), (II) and (III), when 6 or 7 of the residues B₁ through B₈ can be Cys, it is preferred that the residues B₃ through B₇ are Cys.

In the formulae (I), (II) and (III), when 7 of the residues B₁ through B₈ can be Cys, in some embodiments: (a) B₁ and B₃ through B₈ can be Cys and B₂ can be other than Cys; (b) B₁ through B₇ can be Cys and B₈ can be other than Cys, (c) B₁ can be other than Cys and B₂ through B₈ can be Cys. When 7 of the residues B₁ through B₈ are Cys, the other residue can be Ser, Pro or Leu. In some embodiments, B₁ and B₃ through B₈ can be Cys and B₂ can be Ser. In some embodiments, B₁ through B₇ can be Cys and B₈ can be Leu. In further embodiments, B₁ can be Pro and B₂ through B₈ can be Cys.

The cysteine residues of the hydrophobins used in the instant invention can be present in the reduced (that is, “—S—H”) form or, alternatively, can form disulfide (—S—S—) bridges with one another in any possible combination. In some embodiments, when all 8 of the residues B₁ through B₈ are Cys, disulfide bridges can be formed between one or more (preferably at least 2, more preferably at least 3, most preferably all 4) of the following pairs of cysteine residues: B₁ and B₆; B₂ and B₅; B₃ and B₄; B₇ and B₈. In other embodiments, when all 8 of the residues B₁ through B₈ are Cys, disulfide bridges can be formed between one or more (at least 2, or at least 3, or all 4) of the following pairs of cysteine residues: B₁ and B₂; B₃ and B₄; B₅ and B₆; B₇ and B₈.

Examples of specific hydrophobins useful in the instant invention include those described and exemplified in the following publications: Linder et al., FEMS Microbiology Rev. 2005, 29, 877-896; Kubicek et al., BMC Evolutionary Biology, 2008, 8, 4; Sunde et al., Micron, 2008, 39, 773-784; Wessels, Adv. Micr. Physiol. 1997, 38, 1-45; Wo\ddot{s}ten, Annu. Rev. Microbiol. 2001, 55, 625-646; Hektor and Scholtmeijer, Curr. Opin. Biotech. 2005, 16, 434-439; Szilvay et al., Biochemistry, 2007, 46, 2345-2354; Kisko et al. Langmuir, 2009, 25, 1612-1619; Blijdenstein, Soft Matter, 2010, 6, 1799-1808; Wösten et al., EMBO J. 1994, 13, 5848-5854; Hakanpaa et al., J. Biol. Chem., 2004, 279, 534-539; Wang et al.; Protein Sci., 2004, 13, 810-821; De Vocht et al., Biophys. J. 1998, 74, 2059-2068; Askolin et al., Biomacromolecules 2006, 7, 1295-1301; Cox et al.; Langmuir, 2007, 23, 7995-8002; Linder et al., Biomacromolecules 2001, 2, 511-517; Kallio et al. J. Biol. Chem., 2007, 282, 28733-28739; Scholtmeijer et al., Appl. Microbiol. Biotechnol., 2001, 56, 1-8; Lumsdon et al., Colloids & Surfaces B: Biointerfaces, 2005, 44, 172-178; Palomo et al., Biomacromolecules 2003, 4, 204-210; Kirkland and Keyhani, J. Ind. Microbiol. Biotechnol., Jul. 17, 2010 (e-publication); Stübner et al., Int. J. Food Microbiol., 30 Jun. 2010 (epublication); Laaksonen et al. Langmuir, 2009, 25, 5185-5192; Kwan et al. J. Mol. Biol. 2008, 382, 708-720; Yu et al. Microbiology, 2008, 154, 1677-1685; Lahtinen et al. Protein Expr. Purif., 2008, 59, 18-24; Szilvay et al., FEBS Lett., 2007, 5811, 2721-2726; Hakanpaa et al., Acta Crystallogr. D. Biol. Crystallogr. 2006, 62, 356-367; Scholtmeijer et al., Appl. Environ. Microbiol., 2002, 68, 1367-1373; Yang et al, BMC Bioinformatics, 2006, 7 Supp. 4, S16; WO 01/57066; WO 01/57528; WO 2006/082253; WO 2006/103225; WO 2006/103230; WO 2007/014897; WO 2007/087967; WO 2007/087968; WO 2007/030966; WO 2008/019965; WO 2008/107439; WO 2008/110456; WO 2008/116715; WO 2008/120310; WO 2009/050000; US 2006/0228484; and EP 2042156A; the contents of which are incorporated herein by reference.

Hydrophobins are divided into Classes I and II. Hydrophobins of Classes I and II can be distinguished on a number of grounds, including solubility. As described herein, hydrophobins self-assemble at an interface (e.g., a water/air interface) into amphipathic interfacial films. The assembled amphipathic films of Class I hydrophobins are generally re-solubilized only in strong acids (typically those having a pKa of lower than 4, such as formic acid or trifluoroacetic acid), whereas those of Class II are soluble in a wider range of solvents.

Suitable hydrophobins for the instant invention can belong to Class I or Class II hydrophobins.

Class II hydrophobins can comprise hydrophobins having the above-described self-assembly property at a water/air interface, the assembled amphipathic films can re-dissolve to a concentration of at least 0.1% (w/w) in an aqueous ethanol solution (60% v/v) at room temperature. Class I hydrophobins can comprise hydrophobins with the above-described self-assembly property but which do not possess the specified re-dissolution property.

Hydrophobins of Classes I and II can also be distinguished by the hydrophobicity/hydrophilicity of a number of regions of the hydrophobin protein.

Class II hydrophobins can comprise a hydrophobin (as defined and exemplified herein) having the above-described self-assembly property and in which the region between the residues B₃ and B₄, i.e. the moiety (X₃), is predominantly hydrophobic. The Class I hydrophobin can comprise a hydrophobin (as defined and exemplified herein) having the above-described self-assembly property but in which the region between the residues B₃ and B₄, i.e. the group (X₃), is predominantly hydrophilic.

Class II hydrophobins can comprise a hydrophobin having the above-described self-assembly property and in which the region between the residues B₇ and B₈, i.e. the moiety (X₇)_{g}, is predominantly hydrophobic. Class I hydrophobins can comprise a hydrophobin having the above-described self-assembly property but in which the region between the residues B₇ and B₈, i.e. the moiety (X₇)_{g}, is predominantly hydrophilic.

Class II hydrophobins can comprise hydrophobins having the above-described self-assembly property and in which the region between the residues B₃ and B₄, i.e. the moiety (X₃)_{c}, is predominantly hydrophobic. “Class I hydrophobins can comprise hydrophobins having the above-described self-assembly property but in which the region between the residues B₃ and B₄, i.e. the group (X₃)_{c}, is predominantly hydrophilic.

Class II hydrophobins can comprise hydrophobins having the above-described self-assembly property and in which the region between the residues B₇ and B₈, i.e. the moiety (X₇)_{g}, is predominantly hydrophobic. Class I hydrophobins can comprise hydrophobins having the above-described self-assembly property but in which the region between the residues B₇ and B₈, i.e. the moiety (X₇)_{g}, is predominantly hydrophilic.

The relative hydrophobicity/hydrophilicity of the various regions of the hydrophobin protein can be established by comparing the hydropathy pattern of the hydrophobin using the method set out in Kyte and Doolittle, J. Mol. Biol., 1982, 157, 105-132 and in Wessels, Adv. Microbial Physiol. 1997, 38, 1-45.

Class II hydrophobins can also be characterized by their conserved sequences.

Class II hydrophobins suitable for the instant invention can have the general formula (IV):

(Y₁)ₙ—B₁—(X₁)ₐ—B₂-B₃—(X₃)_{c}—B₄—(X₄)_{d}—B₅—(X₅)ₑ—B₆-B₇—(X₇)_{g}—B₈—(Y₂)ₘ (IV)

wherein: Y₁, Y₂ and X₁, X₃, X₄, X₅, and X₇, are as defined above for formula (I); “m” and “n” can each independently be any integer from 0 to 200; B₁, B₂, B₃, B₄, B₅, B₆, B₇ and B₈ are each independently amino acids selected from Cys, Leu, Ala, Ser, Thr, Met or Gly, wherein at least 6 of the residues B₁ through B₈ are Cys; “a” can be any integer from 6 to 12, or alternatively any integer from 7 to 11; “c” can be any integer from 8 to 16, or alternatively any integer from 10 to 12; “d” can be any integer from 2 to 20, or alternatively any integer from 4 to 18; “e” can be any integer from 4 to 12, or alternatively any integer from 6 to 10; and “g” can be any integer from 5 to 15, or alternatively any integer from 6 to 12. Class II hydrophobins suitable for the instant invention can have the general formula (V):

(Y₁)ₙ—B₁—(X₁)ₐ—B₂-B₃—(X₃)_{c}—B₄—(X₄)_{d}—B₅—(X₅)ₑ—B₆-B₇—(X₇)_{g}—B₈—(Y₂)ₘ (V)

wherein: Y₁, Y₂ and X₁, X₃, X₄, X₅, and X₇, are as defined above for formula (IV); “m” and “n” can each independently be any integer from 0 to 10; B₁, B₂, B₃, B₄, B₅, B₆, B₇ and B₈ can each independently be an amino acid selected from Cys, Leu or Ser, wherein at least 7 of the residues B₁ through B₈ are Cys; “a” can be any integer from 7 to 11; “c” can be 11; “d” can be any integer from 4 to 18; “e” can be any integer from 6 to 10; and “g” can be any integer from 7 to 10.

In the formulae (IV) and (V) at least 7 of the residues B₁ through B₈ are Cys, or alternatively all 8 of the residues B₁ through B₈ are Cys.

In the formulae (IV) and (V), in some embodiments, when 7 of the residues B₁ through B₈ are Cys, the residues B₃ through B₇ can be Cys.

In the formulae (IV) and (V), in some embodiments, when 7 of the residues B₁ through B₈ are Cys: (a) B₁ and B₃ through B₈ can be Cys and B₂ can be other than Cys; (b) B₁ through B₇ can be Cys and B₈ can be other than Cys, or (c) B₁ can be other than Cys and B₂ through B₈ can be Cys. In some embodiments, when 7 of the residues B₁ through B₈ are Cys, the other residue can be Ser, Pro or Leu. In some embodiments, B₁ and B₃ through B₈ can be Cys and B₂ can be Ser. In some embodiments, B₁ through B₇ can be Cys and B₈ can be Leu. In some embodiments, B₁ can be Pro and B₂ through B₈ can be Cys.

In the formulae (IV) and (V), in some embodiments, the group (X₃)_{c} can comprise the sequence motif ZZXZ, wherein Z can be an aliphatic amino acid; and X can be any amino acid.

In some embodiments, the group (X₃)_{c} can comprise the sequence motif selected from the group consisting of LLXV, ILXV, ILXL, VLXL and VLXV, wherein “L” is leucine, “V” is valine, and “I” is isoleucine. In some embodiments, the group (X₃)_{c} can comprise the sequence motif VLXV.

In the formulae (IV) and (V), in some embodiments, the group (X₃)_{c} can comprise the sequence motif ZZXZZXZ, wherein Z can be an aliphatic amino acid; and X can be any amino acid. In some embodiments, the group (X₃)_{c} can comprise the sequence motif VLZVZXL, wherein Z can be an aliphatic amino acid; and X can be any amino acid.

The hydrophobin suitable for the instant invention can be obtained from a diverse array of fungi such as Ascomycota, Cladosporium (particularly C. fulvum), Ophistoma (particularly O. ulmi), Cryphonectria (particularly C. parasitica), Trichoderma (particularly T. harzianum, T. longibrichiatum, T. asperellum, T. Koningiopsis, T. aggressivum, T. stromaticum or T. reesei), Gibberella (particularly G. moniliformis), Neurospora (particularly N. crassa), Maganaporthe (particularly M. grisea) or Hypocrea (particularly H. jecorina, H. atroviridis, H. virens or H. lixii).

The suitable hydrophobin for the instant invention can be obtained from fungi of the genus Trichoderma (particularly T. harzianum, T. longibrichiatum, T. asperellum, T. Koningiopsis, T. aggressivum, T. stromaticum or T. reesei). Alternatively, the hydrophobin can be obtained from fungi of the species T. reesei. Further, DNA sequences of many hydrophobins from various microorganisms are available through GENBANK (Maryland, USA). Such DNA sequences can be expressed in a suitable microbial host (by methods well known in the art) and the desired hydrophobin can be produced. Any of these hydrophobins can be suitable for application in the disclosed invention.

The hydrophobin can be present as an initial component of the composition. Alternatively, the hydrophobin can be generated in situ in the composition (for example, by in situ hydrolysis of a hydrophobin fusion protein).

In addition to hydrophobins obtained as described above, hydrophobin derivatives or hydrophobin-like materials comprising chemically modified or genetically modified hydrophobins can also be used in the instant invention. Examples of such hydrophobin modifications include glycosylation, acetylation or by chemical cross-linking for example with glutaraldehyde or by cross-linking with a polysaccharide such as heparin. Hydrophobin-like proteins have the self-assembly property of the original hydrophobin at hydrophilic or hydrophobic interfaces into amphipathic coatings. For the purposes of instant invention, as used herein, the term “hydrophobin” refers to both the naturally obtained hydrophobins as well as those either genetically or chemically modified hydrophobins.

In the instant invention, one type of hydrophobin or a plurality of different types of hydrophobins can be used to disperse the elemental sulfur.

In addition to hydrophobins obtained as described above, hydrophobin-like materials comprising chemically modified or genetically modified hydrophobins can also be used in the instant invention. Examples of such hydrophobin modifications include glycosylation, acetylation or by chemical cross-linking for example with glutaraldehyde or by cross-linking with a polysaccharide such as heparin. Hydrophobin-like proteins have the self-assembly property of the original hydrophobin at hydrophilic or hydrophobic interfaces into amphipathic coatings. For the purposes of instant invention, as used herein, the term “hydrophobin” refers to both the naturally obtained hydrophobins as well as those either genetically or chemically modified hydrophobins.

The aqueous dispersion of the hydrophobin composition can comprise additional components such as additives and/or adjuvants. Examples of such components include, surfactants, e.g., anionic, non-ionic, amphoteric and/or cationic surfactants, acids or bases; non-ionic polymers; polyelectrolytes; buffer systems; inorganic particles, such as SiO₂ or silicates dyestuff; or biocide; UV absorber; and free-radical trapping. Additives can be selected depending on the application or intended use of the coated substrate obtained by the process described herein, or otherwise based on desirable properties or performance enhancements that can result from use of such additives. For example polar organic solvents that are miscible with water such as ethanol, acetone, dioxane, dimethylformamide and dimethylsulfoxide and others can be used.

Hydrophobin oligomers of instant invention are dimers and tetramers obtained from higher molecular weight hydrophobin sources, described hereinabove. Hydrophobin compositions of the instant invention are obtained from high molecular weight hydrophobins according to processes described herein below. Hydrophobin compositions of the instant invention can be in the form of a solution, dispersion, suspension or, alternatively, any mixture of hydrophobin oligomers in an aqueous medium, wherein the oligomers consist essentially of hydrophobin dimers and tetramers of: Class I hydrophobins; Class II hydrophobins; or a mixture of Class I and Class II hydrophobins.

Additional amphiphilic proteins that can be used in the instant invention include, but are not limited to, bovine serum albumin, natural and synthetic silk proteins which have been derived from the natural silk and have been heterologously expressed in suitable prokaryotic or eukaryotic expression systems using genetic engineering methods; wheat proteins; protein hydrolysate, amphiphilic plant-derived or animal-derived proteins; genetically or naturally modified amphiphilic plant-derived or animal-derived proteins; soy wheat protein; monomeric or polymeric amphiphilic proteins. These amphiphilic proteins can be in their natural conformations, or subjected to denaturation treatments to enhance their amphiphilicity.

According to the instant invention, in an embodiment of the invention, the elemental sulfur and the one or more amphiphilic proteins can be contacted directly with the aqueous solution. The term “contact or contacting”, as used herein, refers to adding, pouring, mixing either manually or with a mechanical mixer; stirring or any other method well known in the art. The sequence of contacting each of the elemental sulfur or the one or more amphiphilic proteins is not critical. For example, the one or more amphiphilic proteins can be contacted with the aqueous solution first followed by the elemental sulfur or the elemental sulfur can be contacted with the aqueous solution first followed by the one or more amphiphilic proteins.

Similarly, the process used to achieve effective mixing of the water, sulfur and amphiphilic protein can be varied. For example, the elemental sulfur or the one or more amphiphilic proteins each can be suspended separately in another solution prior to their addition to the aqueous solution. Such solutions, in addition to water, can comprise other additives and/or adjuvants. Examples of such components include, surfactants, e.g., anionic, non-ionic, amphoteric and/or cationic surfactants, acids or bases; non-ionic polymers; polyelectrolytes; buffer systems; inorganic particles, such as SiO₂ or silicates dyestuff; or biocide; UV absorber; and free-radical trapping. The two solutions containing the elemental sulfur and the one or more amphiphilic proteins can then be contacted with the aqueous solution prior to getting mixed.

In yet another embodiment of the invention, the elemental sulfur can be suspended in the aqueous solution first and the one or more amphiphilic proteins can be suspended in another solution, as described above, prior to contacting the aqueous solution containing the dispersed elemental sulfur.

In yet another embodiment of the invention, the one or more amphiphilic proteins can be first contacted with the aqueous solution and the elemental sulfur can be suspended in another solution, as described above, and then contacted with the amphiphilic protein-containing aqueous solution.

The elemental sulfur can be contacted with the essentially aqueous solution “as is”, that is, large yellow pieces. Alternatively, the elemental sulfur can be broken into smaller particles using milling, braking, or chopping by any mechanical equipment, or any other method well known in the relative art, prior to contacting the aqueous solution.

The suspension of the elemental sulfur in the aqueous solution, according to the instant invention, can be prepared by suspending various concentrations of the elemental sulfur in said solution. The concentration of the elemental sulfur in said solution can be up to about 50 wt % relative to the sum of all the weights of components of the aqueous solution. Alternatively, the concentration of elemental sulfur in the suspension can be up to about 20 wt %. In various embodiments of the instant invention the concentration of sulfur in the aqueous solution is from 0.1 wt % to 10 wt %.

The concentration of the one or more amphiphilic proteins in the aqueous solution can be determined by the person skilled in the art. The concentration of the amphiphilic protein in said solution can be at least about 0.0001% wt. The upper limit is dictated by the amphiphilic protein used and its solubility in water. In various embodiments of the instant invention the concentration of either the hydrophobin or the BSA in the aqueous solution is from 0.001 wt % to 0.1% wt.

The instant invention can be practiced at various temperatures up to 75° C. In the instant invention ambient temperature was used to practice the invention. The term “ambient temperature”, as used herein, refers to temperatures between 15° C. to 40° C.

It is not required that the elemental sulfur and the amphiphilic protein are contacted at the same temperature with the aqueous solution. The elemental sulfur can be at a different temperature than the amphiphilic protein composition, or alternatively they can be at the same temperature.

The suspension of the amphiphilic protein and the elemental sulfur in the aqueous solution is to be mixed in order to prepare the sulfur dispersion. Mixing can be performed by any means known to those skilled in the relative art. For example mixing can be done by sonication, microfluidization, stirring, perhaps shaking.

Microfluidization is a process where an aqueous hydrophobin composition is pressurized and pumped through a very narrow valve which generates intense disruptive force to break the protein aggregates.

Sonication involves applying sound energy to agitate particles in a sample. When ultrasonic frequencies (>20 kHz) are used, the process is called ultra-sonication.

Stirring can be performed using either an overhead stirrer or a stir bar inside the solution while the solution container is placed on a magnetic stirrer.

Shaking can be performed manually or mechanically as is customary in the relevant art.

The duration of mixing is determined, based on the type of the amphiphilic protein used by, the person skilled in the art. For example, in the instant invention, mixing can be performed using an ultrasonic probe for a duration of 1 to 120 minutes. In an embodiment of the instant invention, the aqueous solution comprising a hydrophobin and elemental sulfur is sonicated for about 10 minutes. Amphiphilic proteins can be used in compositions in at least one suitable solvent. Suitable solvents for the instant invention can be water or a mixture of water and one or more organic solvents. The nature of the solvent depends on the amphiphilic protein used and its application.

### EXAMPLES

The invention is further described and illustrated in, but not limited to, the following specific embodiments.

The following abbreviations are used in the Examples:
“g” is gram(s); “wt %” is weight percent; “μm” is micrometer(s); and “nm” is nanometer(s); “cm” is centimeter(s).

### Materials and General Methods

Hydrophobin (HFBII) was obtained through fermentation using Tricoderma sp. as a host as disclosed in WO2012054554, WO2012135433, WO2012137147, WO2011019686.
Elemental sulfur was obtained from Sigma-Aldrich (St. Louis, Mo., USA)
Bovine serum albumin was purchased from Sigma-Aldrich (St. Louis, Mo., USA)

### Sonication

A Branson sonicator ultrasonic processor XL (Branson Ultrasonics Corp., Danbury, Conn., United States) was used. Samples were placed in glass vials. The probe was inserted in the vial ˜1-2 cm from the bottom of the vial. The sonicator was set to pulse; 2 seconds sonication, 2 seconds off for a set amount of time.
A Branson 3510 sonication bath was used. Solutions were placed into the sonication bath and sonicated for a set amount of time.

### Example 1

### Sulfur Dispersion in Hydrophobin

To investigate the degree that sulfur disperses in water and how the addition of hydrophobin proteins affects the dispersion of elemental sulfur in water, samples with various concentrations of elemental sulfur and hydrophobin II in deionized water (all based on weight %) were prepared (Table 1).

In detail, the sample of 0% hydrophobin, 0.1% sulfur solution was made up by combining 0.015 g sulfur with 14.985 g deionized water. The sample of 0% hydrophobin, 1% sulfur solution was prepared by combining 0.15 g sulfur and 14.85 g deionized water. The sample of 0% hydrophobin, 10% sulfur solution was prepared by combining 1.5 g sulfur and 13.5 g water. The sample of 0.001% hydrophobin, 0.1% sulfur solution was prepared by combining 0.015 g of sulfur, 0.15 g of 0.1% hydrophobin solution and 14.85 g of deionized water. The sample of 0.001% hydrophobin, 1% sulfur solution was prepared by combining 0.15 g sulfur, 0.15 g of 0.1% hydrophobin solution and 14.85 g of deionized water. The sample of 0.001% hydrophobin, 10% sulfur solution was prepared by combining 1.66 g sulfur, 0.15 g of 0.1% hydrophobin solution and 14.85 g of deionized water. The sample of 0.01% hydrophobin, 0.1% sulfur solution was created by combining 0.015 g sulfur, 1.5 g of 0.1% hydrophobin solution and 13.5 g of deionized water. The sample of 0.01% hydrophobin, 1% sulfur solution was formed by combining 0.15 g of sulfur, 1.5 g of 0.1% hydrophobin solution and 13.5 g of deionized water. The sample of 0.01% hydrophobin, 10% sulfur solution was prepared by combining 1.66 g sulfur, 1.5 g of 0.1% hydrophobin solution and 13.5 g of deionized water. The sample of 0.1% hydrophobin, 0.1% sulfur solution was prepared by combining 0.01 g of sulfur and 9.99 g of 0.1% hydrophobin solution. The sample of 0.1% hydrophobin, 1% sulfur solution was prepared by combining 0.05 g sulfur and 4.95 g of 0.1% hydrophobin solution. Finally, the sample of 0.1% hydrophobin, 10% sulfur solution was prepared by combining 1.5 g sulfur and 13.5 g of 0.1% hydrophobin solution.

All the above samples were then mixed using by placing a stir bar in the sample and leaving the sample on a magnetic stir plate for 48 hours. After stirring for 48 hours, each sample was individually probe sonicated for 10 minutes using a Branson ultra-sonicator on a pulse setting: 2 seconds ultra-sonication, then 2 seconds off.

TABLE 1
Composition of various sulfur and sulfur-hydrophobin dispersions

| | |
|---|---|
| Hydrophobin | Sulfur |

| (wt %) | Wt (grams) | (wt %) | Wt (grams) |
|---|---|---|---|
| 0 | 0 | 0.1 | 0.015 |
| | | 1 | 0.15 |
| | | 10 | 1.5 |
| 0.001 | 0.015 | 0.1 | 0.015 |
| | | 1 | 0.15 |
| | | 10 | 1.66 |
| 0.01 | 0.15 | 0.1 | 0.015 |
| | | 1 | 0.15 |
| | | 10 | 1.66 |
| 0.1 | 0.999 | 0.1 | 0.01 |
| | 0.495 | 1 | 0.05 |
| | 1.35 | 10 | 1.5 |

The stability of the sulfur dispersions after probe sonication (as described above) was evaluated based on their appearances and observation of sedimentation (Table 2). In samples that did not contain hydrophobin and sedimentation was observed right after sonication, the mixture was designated in Table 2 as “No” for formation of an initial dispersion. In samples that contained various concentrations of both sulfur and hydrophobin, if an initial dispersion was obtained, the mixture was observed to determine whether sedimentation was formed within 24 hours of sonication. If no sedimentation was observed 24 hours after sonication, the dispersion was considered stable for the purposes of the present invention. In the absence of hydrophobin, the yellow sulfur particles remained visible and largely unchanged throughout the sonication process and sedimentation was observed. Thus, no stable sulfur dispersions were produced.

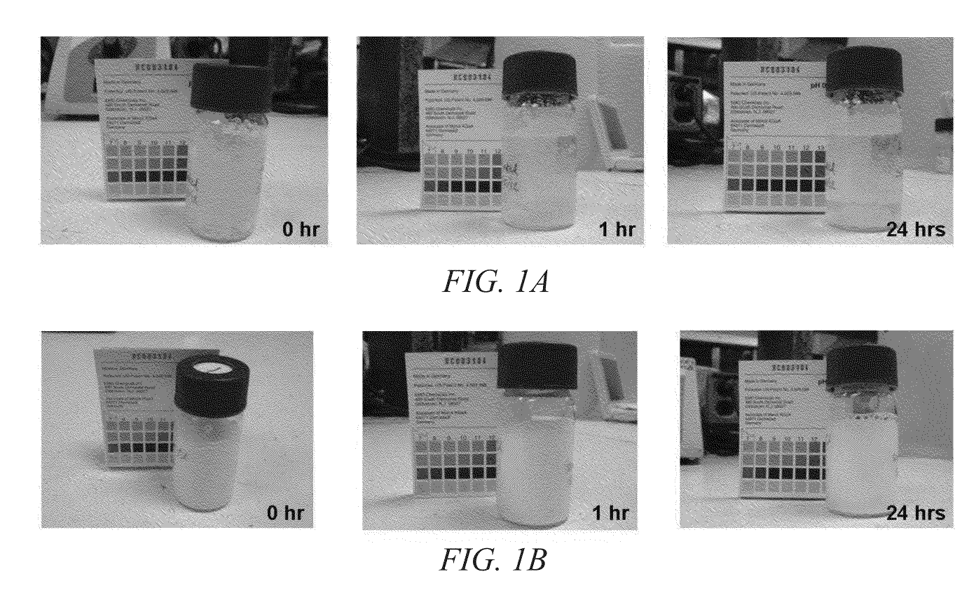

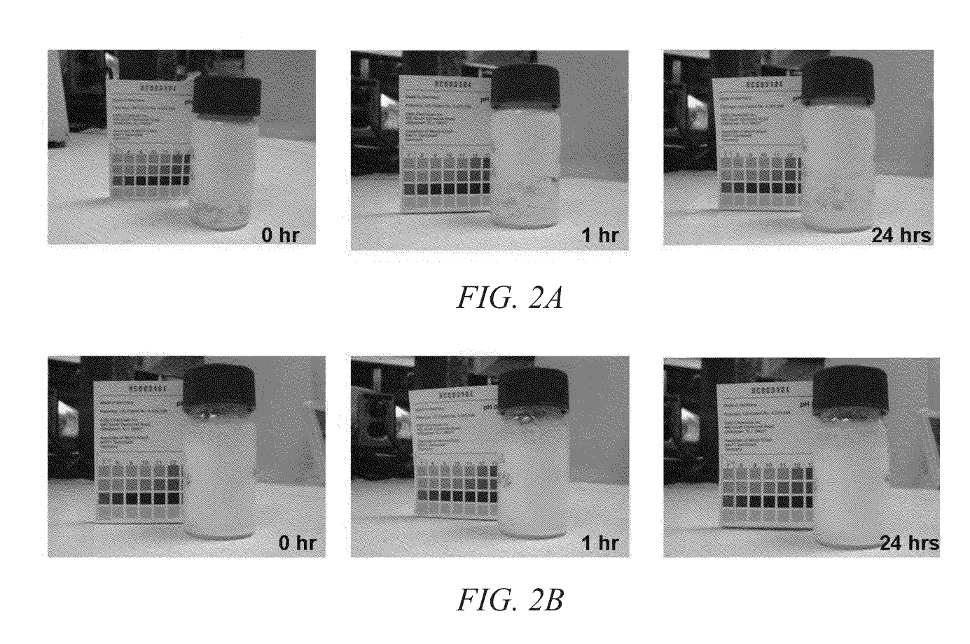

The addition of hydrophobin noticeably increased the dispersibility of sulfur particles and resulted in production of milk-like stable dispersions (FIGS. 1A, 1B, 2A and 2B).

The stability of the sulfur dispersion in the presence of hydrophobin is a function of concentration of sulfur versus concentration of hydrophobin as shown in Table 2.

TABLE 2
Dispersion stability of various samples prepared above

| | | | Dispersion |
|---|---|---|---|
| | Concentration of | Initial | stability after 24 |
| Sample | solution | dispersion | hours |
| 1 | 0% hydrophobin, 0.1% | No | No |
| | sulfur | | |
| 2 | 0.001% hydrophobin, | Yes | No |
| | 0.1% sulfur | | |
| 3 | 0.01% hydrophobin, | Yes | Yes |
| | 0.1% sulfur | | |
| 4 | 0.1% hydrophobin, | Yes | Yes |
| | 0.1% sulfur | | |
| 5 | 0% hydrophobin, 1% | No | No |
| | sulfur | | |
| 6 | 0.001% | No | No |
| | hydrophobin, 1% sulfur | | |
| 7 | 0.01% hydrophobin, | Yes | Yes |
| | 1% sulfur | | |
| 8 | 0.1% hydrophobin, 1% | Yes | Yes |
| | sulfur | | |
| 9 | 0% hydrophobin, 10% | No | No |
| | sulfur | | |
| 10 | 0.001% | No | No |
| | hydrophobin, 10% sulfur | | |
| 11 | 0.01% hydrophobin, | Yes | No |
| | 10% sulfur | | |
| 12 | 0.1% hydrophobin, | Yes | Yes |
| | 10% sulfur | | |

### Example 2

### Sulfur Dispersions with BSA

To investigate if other amphiphilic proteins would have the ability to efficiently disperse the elemental sulfur, a new set of samples were prepared as described in Example 1 with the exception that the hydrophobin in the samples was replaced with bovine serum albumin (BSA). Concentrations of sulfur and the BSA were as those shown in Table 1.

Similar to Example 1, all these samples were left stirring on a magnetic stir plate for 48 hours before they were individually sonicated as described above. Sulfur dispersions was determined based on visible sedimentation in the samples (Table 3). The addition of BSA improved elemental sulfur dispersion in water, but the long-term stability of the dispersions was lower than those observed when hydrophobin was used to disperse the elemental sulfur. Sulfur was dispersed using 0.001% BSA and 0.1% sulfur. However, this dispersion was not stable and at 24 hours phase separation was observed. As the concentration of BSA was increased in the solution, sulfur dispersion showed more stability. At 0.1% BSA and 10% sulfur, after 24 hours, the sulfur dispersion remained stable and no phase separation was observed.

In conclusion, BSA was effective in dispersing elemental sulfur only at high concentrations.

TABLE 3
Elemental sulfur dispersion stability at various concentrations of BSA

| | Concentration of | Initial | Dispersion |
|---|---|---|---|
| Sample | solution | dispersion | after 24 hours |
| 1 | 0% BSA, 0.1% | No | No |
| | sulfur | | |
| 2 | 0.001% BSA, | Yes | No |
| | 0.1% sulfur | | |
| 3 | 0.01% BSA, 0.1% | Yes | Yes |
| | sulfur | | |
| 4 | 0.1% BSA, 0.1% | Yes | Yes |
| | sulfur | | |
| 5 | 0% BSA, 1% | No | No |
| | sulfur | | |
| 6 | 0.001% BSA, 1% | No | No |
| | sulfur | | |
| 7 | 0.01% BSA, 1% | Yes | Yes |
| | sulfur | | |
| 8 | 0.1% BSA, 1% | Yes | No |
| | sulfur | | |
| 9 | 0% BSA, 10% | No | No |
| | sulfur | | |
| 10 | 0.001% BSA, 10% | No | No |
| | sulfur | | |
| 11 | 0.01% BSA, 10% | No | No |
| | sulfur | | |
| 12 | 0.1% BSA, 10% | No | No |
| | sulfur | | |

What is claimed is:

1. A process for preparing an aqueous dispersion of elemental sulfur, the process comprising the step mixing one or more amphiphilic proteins, elemental sulfur and water to form an aqueous dispersion of elemental sulfur.

2. The process of claim 1 wherein the amphiphilic protein and the elemental sulfur are nixed prior to being mixed with water.

3. The process of claim 1 wherein the elemental sulfur is added to water before the amphiphilic protein is added.

4. The process of claim 1 wherein the elemental sulfur is milled prior to mixing with water.

5. The process of claim 1 wherein the amphiphilic protein is hydrophobin.

6. The process of claim 1 wherein the amphiphilic protein is bovine serum albumin.

7. The process of claim 1 wherein the mixing is performed by sonication.

8. The process of claim 1 wherein the aqueous dispersion further comprises acids, bases, buffers, polar organic solvents selected from a group consisting of ethanol, acetone, dioxane, dimethylformamide and dimethylsulfoxide.

9. The process of claim 8 wherein the aqueous dispersion comprises at east 50% water.

10. The process of claim 1 wherein the concentration of elemental sulfur in the aqueous dispersion is about 50 weight %.

11. The process of claim 10 wherein the concentration of elemental sulfur in the aqueous dispersion is about 20 weight %.

12. The process of claim 11 wherein the concentration of elemental sulfur in the aqueous dispersion is from 0.1 weight % to 10 weight %.

13. The process of claim 1 wherein the concentration of the amphiphilic protein in the aqueous dispersion is at least about 0.0001 weight %.

14. The process of claim 13 wherein the concentration of the amphiphilic protein in the aqueous dispersion is from 0.001 weight % to 0.1 weight %.

15. A composition comprising elemental sulfur coated with an amphiphilic protein.

16. The composition of claim 15 wherein the amphiphilic protein is selected from: Class I hydrophobins; Class II hydrophobins; bovine serum albumin; or mixtures thereof.

17. The composition of claim 15 wherein the amphiphilic protein is selected from Class I hydrophobins, Class II hydrophobins, or mixtures thereof.

18. The composition of claim 15 wherein the amphiphilic protein is bovine serum albumin.
